(19) United States
(12) Patent Application Publication
(10) Pub. No.: US 2003/0179739 A1
(43) Pub. Date: Sep. 25, 2003

(54) Radio communication device and communication system using the same

(75) Inventor: Manabu Yamamoto, Kyoto (JP)

Correspondence Address: FOLEY AND LARDNER, SUITE 500, 3000 K STREET NW, WASHINGTON, DC, 20007, US

(73) Assignee: OMRON CORPORATION

(21) Appl. No.: 10/231,484

(22) Filed: Aug. 30, 2002

(30) Foreign Application Priority Data
Sep. 4, 2001 (JP) 2001-267003

(51) Int. Cl. H04J 3/24

(52) U.S. Cl. 370/349; 370/389

(57) ABSTRACT

To provide a radio communication device and a communication system using the same wherein the probability of packet collision is reduced without modification of DTE-side communication software in a communication system that performs radio transmission of packets from a source DTE to a plurality of destination DTEs. In a radio communication device to be used in a communication system for performing radio transmission of packets including destination address between a source DTE and a plurality of destination DTEs its own address in a communication system is set identical to an address of the DTE, interpretation is carried out as to whether a destination address included in a command received from an arbitrary radio communication device is the own address or an address of a different radio communication device, and packet transmission is then performed corresponding to the interpretation.

### BACKGROUND OF THE INVENTION

1. Field of the Invention

The present invention relates to a radio communication device and a communication system using the same; more specifically, the present invention relates to a communication system wherein packets are transmitted from a source DTE (data terminating equipment) to a plurality of destination DTEs through radio communication devices thereof.

2. Description of the Background Art

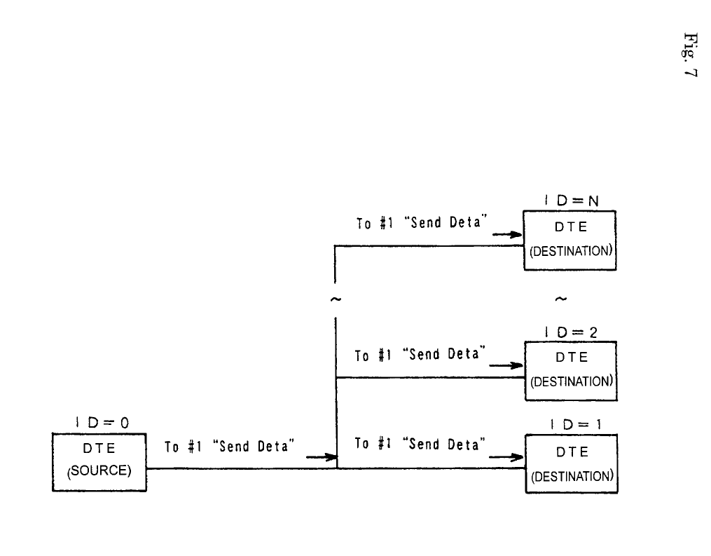

In a communication system shown in FIG. 7, a source DTE (ID=0) and a plurality of destination DTEs (ID=1), (ID=2), and (ID=N) are mutually hardwired. In an event a packet has been transmitted from the source DTE (ID=0) to each of the destination DTEs (ID=1), (ID=2), and (ID=N), each of the destination DTEs (ID=1), (ID=2), and (ID=N) determines whether a destination address of a command included in the packet is its own address or not. If the address is the own address, the destination DTE performs a retrieval process for data included in the packet; whereas if the address is not the own address, the destination DTE discards the packet and does not return an ACK.

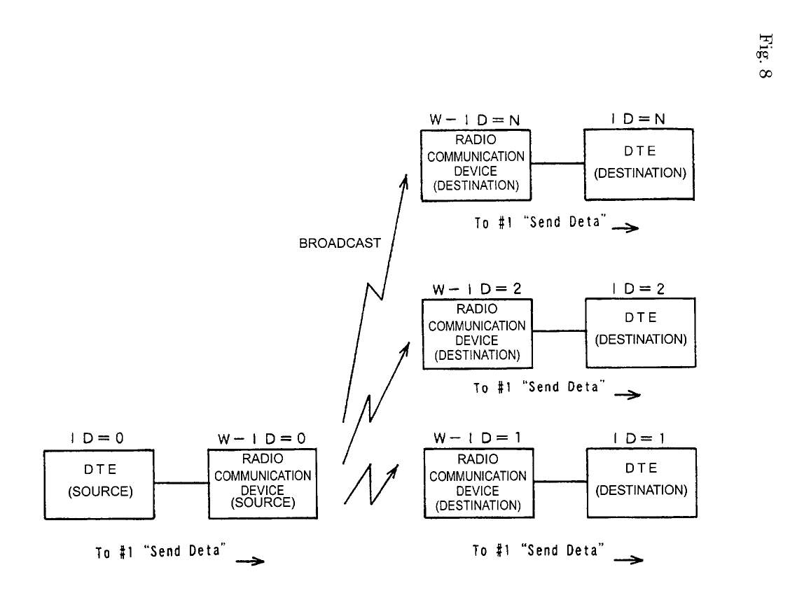

FIG. 8 shows a case where the above-described communication system is arranged such that a radio communication device (W-ID=0) is hardwired to the source DTE (ID=0), and in addition, radio communication devices (W-ID=1), (W-ID=2), and (W-ID=N) are hardwired to the destination DTEs (ID=1), (ID=2), and (ID=N), respectively. In the configuration, when a packet is transmitted from the source DTE (ID=0) to each of the destination DTEs (ID=1), (ID=2), and (ID=N), the packet needs to be broadcast between in a radio coverage area between the source radio communication device (W-ID=0) and each of the destination radio communication devices (W-ID=1), (W-ID=2), and (W-ID=N). When the communication configuration is modified as above, communication software of each of the source DTE (ID=0) and destination DTEs (ID=1), (ID=2), and (ID=N) need not to be modified. This is because the radio communication device itself does not need to have its own address.

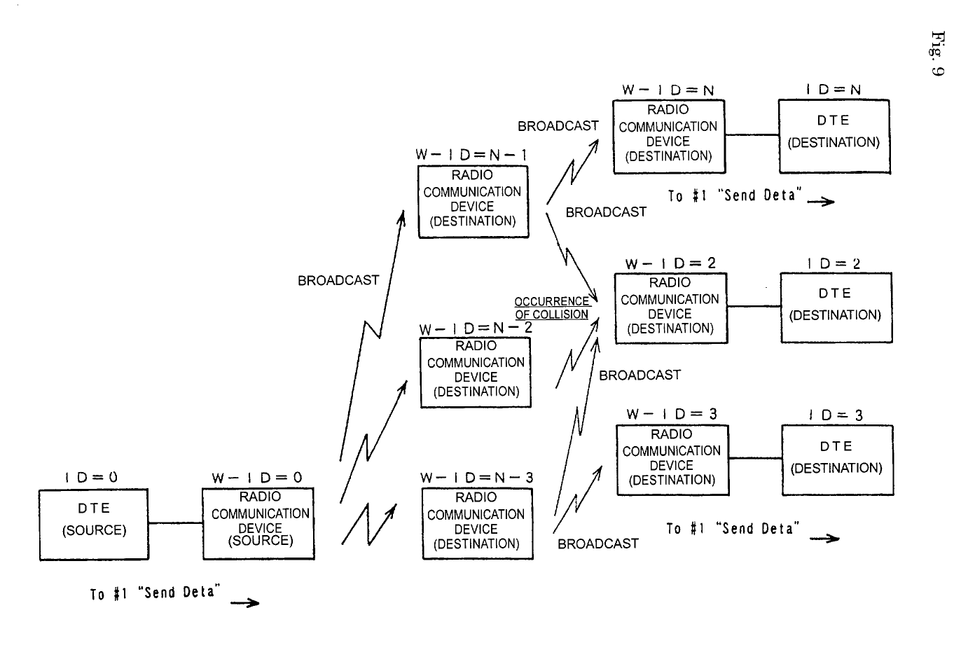

Suppose a radio wave transmitted from the radio communication device (W-ID=0) of the source DTE (ID=0) does not arrive at the radio communication devices (W-ID=1), (W-ID=2), and (W-ID=N) of the destination DTEs (ID =1), (ID=2), and (ID=N). In this case, the configuration may be arranged such that, as shown in FIG. 9 for example, packets are wireless-transmitted from the radio communication device (W-ID=0) of the source DTE (ID=0) to relay radio communication devices (W-ID=N−1), (W-ID=N−2), and (W-ID=N−3); the packets are then wireless-transmitted from the relay radio communication devices (W-ID=N−1), (W-ID=N−2), and (W-ID=N−3) to radio communication devices (W-ID=N), (W-ID=2), and (W-ID=3); and the packets are then transmitted from the radio communication devices (W-ID=N), (W-ID=2), and (W-ID=3) to destination DTEs (ID=N), (ID=2), and (ID=1) hardwired thereto.

In the case where the modification is thus made from the communication system shown in FIG. 8 to the communication system shown in FIG. 9, problems are pointed out as described below.

The packets are transmitted via broadcast communication from the source radio communication device (W-ID=0) to the plurality of relay radio communication devices (W-ID=N−1), (W-ID=N−2), and (W-ID=N−3). Then, the individual relay radio communication devices (W-ID=N−1), (W-ID=N−2), and (W-ID=N−3) transmit the packets to the destination radio communication devices (W-ID=N), (W-ID=2), and (W-ID=3) in broadcast communication.

In the above case, the relay radio communication devices (W-ID=N−1), (W-ID=N−2), and (W-ID=N−3) are not capable of mutually adjusting timing in the broadcast communication. As such, for example, when the individual relay radio communication devices (W-ID=N−1), (W-ID=N−2), and (W-ID=N−3) have synchronously performed broadcast communications to the single destination radio communication device (W-ID=2), the packets transmitted from the individual relay radio communication devices (W-ID=N−1), (W-ID=N−2), and (W-ID=N−3) cause mutual collisions in the destination radio communication device (W-ID=2).

To prevent the aforementioned collisions, suppose the configuration has been arranged such that broadcast communications are not performed in the radio coverage areas, and only a radio communication device related to the route to the destination is used. In this configuration, however, necessities arise for setting of addresses for the individual radio communication devices and for modification of the communication software of the source DTE (ID=0) and the destination DTEs (ID=N), (ID=2), and (ID=3).

In addition, when using the broadcast communication, the source DTE (ID=0) does not perform delivery verification. As such, despite the probability in occurrence of transmission data loss, error control operations such as a detection of transmission data loss in the radio coverage area and a retry operation cannot be performed, thereby the reliability in the packet transmission is reduced.

Further, the source DTE (ID=0) is charged with the responsibility for performing the transmission verification and error control operations of transmission data. In this case, while the radio coverage area should inherently be responsible for the line quality deterioration occurring due to the insertion of the radio coverage area where the line quality is relatively low in comparison to the hardwired case, the source DTE needs to cover it through software processing. Thereby, the source DTE is increasingly burdened.

### SUMMARYOF THE INVENTION

Accordingly, an object of the present invention is to provide a radio communication device and a communication system using the same in which the probability of packet collision in the relaying of the packet transmission is reduced without modification of DTE-side communication software in the communication system that performs radio transmission of packets from a source DTE to a plurality of destination DTEs.

Another object of the present invention is to provide a radio communication device and a communication system using the same in which the probability of data loss is reduced without modification in DTE-side communication software in a communication system that performs radio transmission of packets from the source DTE to a plurality of destination DTEs.

Still another object of the present invention is to provide a radio communication device and a communication system using the same in which error control can be implemented in a radio coverage area, reliability in packet transmission can be increased, and the burden of software of the source DTE can be reduced in the communication system that performs radio transmission of packets from the source DTE to a plurality of destination DTEs.

(1) A radio communication device of the invention is used with a communication system wherein packets each including a destination address are radio-transmitted between a plurality of DTEs, and is characterized in that the radio communication device can be set to have an own address in the communication system in a pattern identical to or associated with that of an address allocated to the DTE, interpretation is performed as to whether a destination address included in a packet received in an arbitrary radio communication device is the own address or an address of a different radio communication device, and operation corresponding to the address subjected to the interpretation is performed.

According to the invention described above, since each of the radio communication devices has the address, packet collision does not occur during relaying transmission of packets from a source to a destination. In this case, since the address of the radio communication device is set to the same address as that of the hardwired DTE, communication software of the DTE need not to be modified. In addition, the radio communication devices mutually have the addresses, transmission verification can be implemented, and the probability in occurrence of data loss is reduced. Further, since error control operations such as a data loss detection and a retry operation can be implemented, the reliability in packet transmission can be improved. Furthermore, since the data transmission verification and error control operations can be implemented with the radio communication device, line quality deterioration occurring due to wireless arrangement can be covered on the side of the radio communication device, thereby eliminating a burden to be imposed on the software of the DTE.

The invention is preferably arranged such that when the radio communication device is hardwired to a DTE in the communication system, it is set to have the same address as the address of the DTE in the communication system and is thereby used.

In addition, the invention is preferably arranged such that when a DTE for relaying a packet communication between at least two radio communication devices in the communication system is not hardwired, the radio communication device can be set to have an own address in the communication system in a pattern identical to or associated with that of the address allocated to the DTE.

Further, the invention is preferably arranged such that in the interpretation of the destination address, a command header, an offset value for fields of from the command header to the destination address, the number of fields in the destination address, and a setting method of the destination address are used as parameters.

Furthermore, the invention is preferably arranged such that the radio communication device is hardwired to a source DTE and is thereby used, and a radio packet including a destination address included in a packet transmitted from the source DTE as a destination radio-communication-device address can be transmitted in a radio coverage area between the radio communication device and a different radio communication device.

(2) A first communication system of the invention is a communication system wherein wireless transmission of packets each including a destination address is performed between a plurality of DTEs by using a radio communication device, and is characterized in that the radio communication device is set to have an address identical to an address allocated to the DTE as an own address thereof in the communication system, performs interpretation of a destination address included in a packet received from a different radio communication device, and performs a transmission operation of the packet corresponding to the interpretation.

According to the invention described above, since each of the radio communication devices has the address, packet collision does not occur during relaying transmission of packets from a source to a destination. In this case, since the address of the radio communication device is set to the same address as that of the DTE, communication software of the DTE need not to be modified. In addition, the radio communication devices mutually have the addresses, transmission verification can be implemented, and the probability in occurrence of data loss is reduced. Further, since error control operations such as a data loss detection and a retry operation can be implemented, the reliability in packet transmission can be improved. Furthermore, since the data transmission verification and error control operations can be implemented with the radio communication device, line quality deterioration occurring due to wireless arrangement can be covered on the side of the radio communication device, thereby a burden to be imposed on the software of the DTE is eliminated.

The first one of the invention is preferably arranged such that in the interpretation of the destination address, a command header, an offset value for fields of from the command header to the destination address, the number of fields in the destination address, and a setting method of the destination address are used as parameters.

(3) A second communication system of the invention is a communication system wherein packets each including a destination address are transmitted from a source DTE to a plurality of destination DTEs by radio communication devices, and is characterized in that the radio communication devices are individually hardwired to the source DTE and the destination DTE, each of the radio communication devices is set to have an address identical to an address allocated to the hardwired DTE as an own address thereof in the communication system, performs interpretation of a destination address included in a packet received from a different radio communication device, and performs a transmission operation of the packet corresponding to the interpretation.

The second one of the invention is preferably arranged such that in the case of performing transmission of the packet between the radio communication device of the source DTE and the radio communication device of the destination DTE, when relaying is performed by using the radio communication devices hardwired to the DTEs, the addresses of the DTEs connected thereto are set as addresses of the relay radio devices in the communication system.

The second one of the invention is preferably arranged such that in the case of performing transmission of the packet between the radio communication device of the source DTE and the radio communication device of the destination DTE, when relaying is performed by using standalone radio communication devices, addresses of the relay radio devices in the communication system are allocated and set corresponding to the addresses of the DTEs.

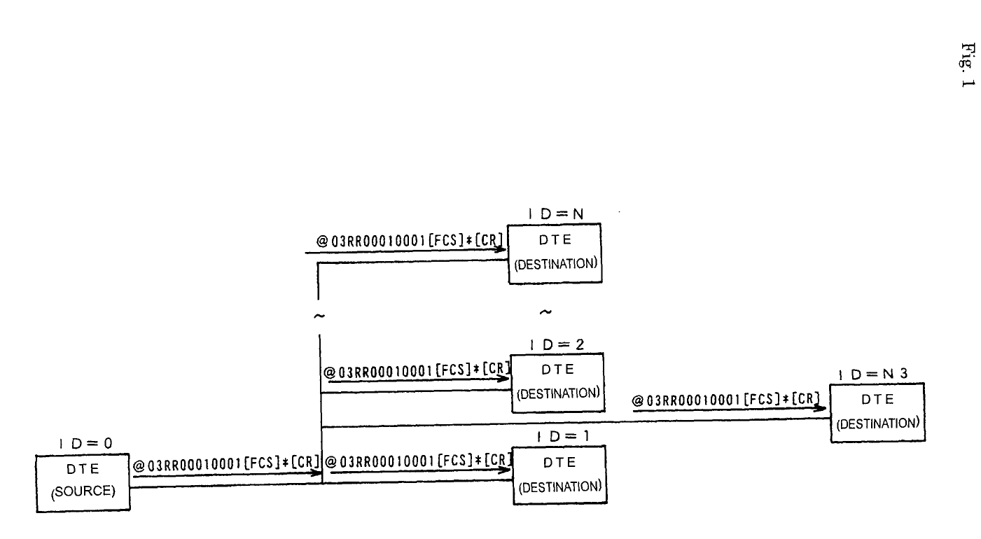

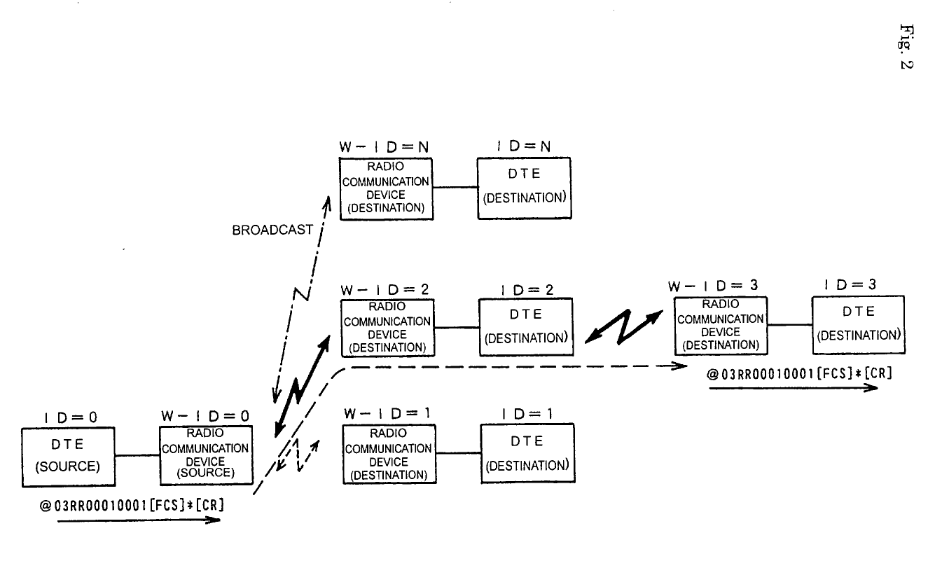

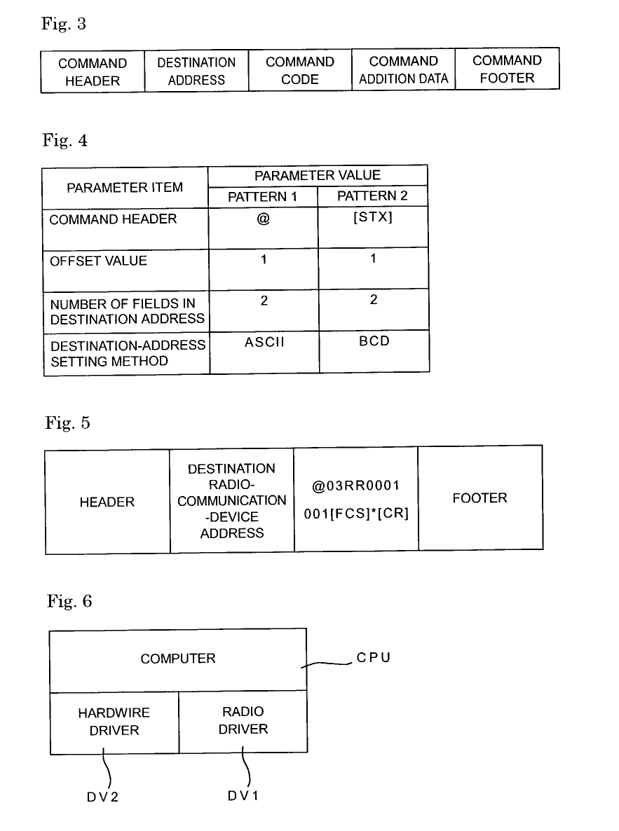

### BRIEF DESCRIPTION OF THE DRAWINGS

[FIG. 1] A view showing the configuration of a 1-vs-N hardwired communication system.

[FIG. 2] A view showing the configuration of a 1-vs-N radio communication system according to an embodiment of the present invention.

[FIG. 3] A composition view of a command included in a packet in the radio communication system shown in FIG. 2.

[FIG. 4] A view showing the composition of the command shown in FIG. 3.

[FIG. 5] A composition view a radio packet format.

[FIG. 6] A block diagram of a radio communication device shown in FIG. 2.

[FIG. 7] A view showing the configuration of a conventional 1-vs-N hardwired communication system.

[FIG. 8] A view showing the configuration of a conventional 1-vs-N radio communication system.

[FIG. 9] A view showing the configuration of a 1-vs-N radio communication system including conventional relay radio communication devices.

### REFERENCE NUMERALS

ID=0: source DTE

ID=1, ID=2, ID=3, and ID=N: destination DTE

### DESCRIPTION OF THE PREFERRED EMBODIMENTS

Hereinbelow, the present invention will be described in detail with reference to embodiments shown in the drawings.

A communication system shown in FIG. 1 is configured such that a source DTE (ID=0) is connected to a plurality of destination DTEs (ID=1), (ID=2), (ID=3), and (ID=N) via hardwires (for example, RS-485 cables). The number of the destination DTEs to be provided is not limited to the above. In addition, it is optional to use the DTE as the source or the destination; that is, any one of the DTEs can transmit and receive the packet and functions either as the source or as the destination. Since an internal circuit of the DTE is well-known, it is not illustrated. Any one of the circuits includes a built-in computer in which communication software for executing processes including those for a communication protocol necessary to implement the packet transmission in the communication system is installed. The above matters are similar to those in a communication system shown in FIG. 2.

Hereinbelow, the communication system shown in FIG. 2 will be described. The communication system shown in FIG. 2 is configured such that a radio communication device is connected to a source DTE (ID=0) via a hardwire (for example, an RS-232C cable), and radio communication devices (W-ID=1), (W-ID=2), (W-ID=3), and (W-ID=N) are connected to a plurality of destination DTEs (ID=1), (ID=2), (ID=3), and (ID=N), respectively, with hardwires (for example, RS-232C cables).

In each of the communication systems shown in FIGS. 1 and 2, an address of the source DTE (ID=0) is set to “00”, and respective addresses of the destination DTEs (ID=1), (ID=2), (ID=3), and (ID=N) are set to “01”, “02”, “03”, and “ON”.

A command is included in a packet transmitted to each of the destination DTEs (ID=1), (ID=2), (ID=3), and (ID=N) from the source DTE (ID=0). As will be described below with reference to FIG. 3, the aforementioned command includes a command header, a destination address, a command code, command addition data, and a command footer.

As will be described hereafter with reference to FIG. 4, a parameter of the command has a pattern 1 and a pattern 2. In the pattern 1, the command header is a “@”, an offset value for each of the values from the top of the command header to the destination address is “1”, the number of fields (number of bytes) of the destination address is “2”, and a setting method of the destination address is the “ASCII code”. For the pattern 2, the command header is “STX”, an offset value for each of the values from the top of the command header to the destination address is “1”, the number of fields of the destination address is “2”, and a setting method of the destination address is the “BCD code”.

These patterns are shown only by way of example, and the present invention is in no way limited to these patterns.

In the pattern 1, for example, in a packet having a command represented by “@03RR00010001[FCS]*[CR]”, in which “@” is the command header. In addition, since the offset value is “1”, and the number of fields is “2”, “03” after “@” represents the destination address. In addition, “RR” is the command code, “00010001[FCS]” represents the command addition data, and “CR” is the command footer.

Accordingly, the packet exemplified above is transmitted to a destination DTE (ID=3) of which the address is “03”.

The present embodiment has a feature of enabling each DTE to modify the communication system from one shown in FIG. 1 to one shown in FIG. 2 without modification of the communication software.

In specific, the present embodiment has a feature in which own addresses in the communication system are allocated to the radio communication devices, which are used in the communication system, as radio-communication-device addresses identical to addresses of the individually hardwired DTEs. Each of the radio communication devices carries out interpretation as to whether a destination address included in a command received from another radio communication device is its own address or an address of still another radio communication device. Thereby, the radio communication device is enabled to perform a packet transmission corresponding to the interpretation.

In more specific, the radio communication device (W-ID=0) connected to the source DTE (ID=0) sets the address “00” of the source DTE (ID=0) as its own address. The radio communication device (W-ID=1) connected to the destination DTE (ID=1) sets the address “01” of the destination DTE (ID=1) as its own address. Similarly, the other radio communication devices individually set their own addresses. Specifically, the radio communication device (W-ID=2) connected to the destination DTE (ID=2) sets the address “02” of the destination DTE (ID=2), the radio communication device (W-ID=3) connected to the destination DTE (ID=3) sets the address “03” of the destination DTE (ID=3), and the radio communication device (W-ID=N) connected to the destination DTE (ID=N) sets the address “ON” of the destination DTE (ID=N).

As shown in FIG. 3, a packet format (hardwire coverage area format) of a packet to be transmitted from the source DTE (ID=0) to the radio communication device (W-ID=0) hardwired thereto is the same as a packet format (hardwire coverage area format) of a packet to be transmitted from each of the radio communication devices (W-ID=N), (W-ID=2), (W-ID=1), and (W-ID=3) to each of the destination DTEs (ID=1), DTE (ID=2), DTE (ID=3), and DTE (ID=N) hardwired thereto. However, a packet format (radio-coverage-area packet format) to be transmitted from the source radio communication device (W-ID=0) to each of destination radio communication devices (W-ID=N), (W-ID=2), (W-ID=1), and (W-ID=3) is different from the hardwire coverage area format.

As shown in FIG. 5, the radio-coverage-area packet format is composed of a radio-packet header, a destination radio-communication-device address, packet data shown in FIG. 3, and a radio-packet footer.

Thus, the radio packet shown in FIG. 5 is transmitted in the radio coverage area. As such, when the packet shown in FIG. 3 is transmitted from the source DTE (ID=0), the radio packet shown in FIG. 5 is transmitted from the radio communication device (W-ID=0) to the destination radio communication devices (W-ID=1), (W-ID=2), (W-ID=3), and (W-ID=N). As a result, each of thedestination radio communication devices (W-ID=1), (W-ID=2), (W-ID=3), and (W-ID=N) receives the radio packet.

For example, when the destination radio communication device (W-ID=1) has received the aforementioned radio packet, the destination radio communication device (W-ID=1) reads a destination radio-communication-device address in the radio packet, and recognizes the destination radio-communication-device address as “03”. Thereby, the destination radio communication device interprets that the destination radio-communication-device address is not the own address and that the packet is transmitted to the destination radio communication device (W-ID=3) of which a destination radio-communication-device address is “03”, and therefore, does not perform packet transmission.

Similarly, when the radio communication device (W-ID=2) has received the radio packet, the radio communication device (W-ID=2) reads a destination radio-communication-device address in the radio packet, and recognizes the destination radio-communication-device address as “03”. Thereby, the destination radio communication device interprets that the destination radio-communication-device address is not the own address and that the packet is transmitted to the destination radio communication device (W-ID=3) of which the destination radio-communication-device address is “03”, and therefore, does not perform packet transmission.

Similarly, when the destination radio communication device (W-ID=N) has received the radio packet, the destination radio communication device (W-ID=N) reads a destination radio-communication-device address in the radio packet, and recognizes the destination radio-communication-device address as “03”. Thereby, the destination radio communication device interprets that the destination radio-communication-device address is not the own address and that the packet is transmitted to the destination radio communication device (W-ID=3) of which the destination radio-communication-device address is “03”, and therefore, does not perform packet transmission.

Similarly, when the destination radio communication device (W-ID=3) has received the radio packet, the destination radio communication device (W-ID=3) reads a destination radio-communication-device address in the radio packet, and recognizes the destination radio-communication-device address as “03”. Thereby, the destination radio communication device interprets that the destination radio-communication-device address is its own address and that the packet is transmitted to the own address, and therefore transmits the packet to the communication destination DTE (ID=3).

Each of the own addresses of the radio communication devices on the individual sides may preferably be set by using hardware such as a DIP switch or a setting-dedicated command (software).

The DTE and the radio communication device may be integrated into a communication unit. In this case, since the radio communication device need not to be deliberately connected to the external DTE, the configuration of the communication system is facilitated.

For example, there is a case of constructing a communication system in which packets need to be radio-exchanged between a center-side DTE and multiple terminal-side DTEs in monitoring such as a state of monitoring for various machines in a factory or a state of monitoring for vending machines. In this case, according to the present embodiment of the communication system, when the modification is performed from the communication system shown in FIG. 1 to the communication system shown in FIG. 2, the communication software of the DTE need not be modified. As such, the present embodiment is significantly advantageous in the construction of the communication system.

In the above, there can be a case where transmission cannot be achieved because of, for example, a long distance between the source radio communication device (W-ID=0) and the destination radio communication device (W-ID=3) or for the reason that radio wave for transmitting a packet from the source radio communication device (W-ID=0) to the destination radio communication device (W-ID=3) is weakened by disturbances or the like.

Among the source radio communication devices, for example, suppose the radio communication device (W-ID=2) is in a radio-wave transmitting/receiving state where relaying can be performed between the two radio communication devices (W-ID=0) and (W-ID=3). In this case, the radio communication device (W-ID=2) interprets that the destination address to which a packet has been transmitted from the radio communication device (W-ID=2) is not its own address and that the packet is addressed to be transmitted to the destination radio communication device (W-ID=3) of which the address is “03”. Then, according to the interpretation, the radio communication device (W-ID=3) transmits the packet, which has been addressed to the destination radio communication device (W-ID=3). In this case, since corresponding communication software is preinstalled in the individual radio communication devices, and communication software of the DTEs need not to be modified at all.

In the above relaying operation, when all the destination radio communication devices themselves are associated with the interplaying route for the packet transmitted from the source DTE (ID=0), the arrangement may be made such that the packet is transmitted to another source radio communication device.

As described above, even when performing relaying in the communication system of the present embodiment, no other operations are required for the DTEs than the operation of transmitting packets to individual radio communication devices, and the relaying can be implemented without modification of the communication software of the individual DTEs.

In the above, the radio communication device for performing the relaying is hardwired to the DTE. However, there can be a case in which radio communication devices for performing relaying are not connected to DTEs. In this case, for addresses of the radio communication devices working as standalone relay devices, their own addresses within the communication system may be allocated and set thereto corresponding to the addresses of the individual source or destination DTEs.

As described above, according to the present embodiment, since the individual radio communication devices have their own addresses, no packet collision can occur when performing relay transmissions of packets from the source to the destinations. In addition, in the above case, since the same addresses of the hardwired DTEs are set for the addresses of the radio communication devices, the communication software of the DTEs need not to be modified.

Moreover, since the radio communication devices mutually have their addresses, transmission verifications can be implemented, and the probability of data loss is decreased. Further, since error control operations such as data loss detections and retry operations can be implemented, the reliability in the packet transmission can be improved.

Furthermore, since the data-transmission verification and the error control operations can be implemented with the radio communication device, the line quality deterioration occurring due to wireless arrangement can be covered on the side of radio communication devices. Consequently, a burden to be imposed on the software in the DTE can be eliminated.

As shown in FIG. 6, the radio communication device may be configured to include a computer CPU in which communication-dedicated application software is installed, a hardwire driver DV1 hardwired to a DTE, and a radio driver DV2 for transmitting radio waves to another radio communication device and receiving radio waves therefrom.

The packet can be executed in the same manner as that described above even when it has been received in the state of the above-described pattern 2.

As described above, according to the present invention, while the probability of packet collision is reduced, and packet relaying transmission can be implemented without modifying DTE-side communication software.

What is claimed is:

1. A radio communication device to be used with a communication system wherein packets each including a destination address are wireless-transmitted between a plurality of DTEs, characterized in that the radio communication device can be set to have an own address in the communication system in a pattern identical to or associated with that of an address allocated to the DTE, interpretation is performed as to whether a destination address included in a packet received in an arbitrary radio communication device is the own address or an address of a different radio communication device, and operation corresponding to the address subjected to the interpretation is performed.

2. The radio communication device as stated in claim 1, characterized in that when the radio communication device is hardwired to a DTE in the communication system, the radio communication device is set to have the same address as the address of the DTE in the communication system and is thereby used.

3. The radio communication device as stated in claim 1, characterized in that when a DTE for relaying a packet communication between at least two radio communication devices in the communication system is not hardwired, the radio communication device can be set to have an own address in the communication system in a pattern identical to or associated with that of the address allocated to the DTE.

4. The radio communication device as stated in one of claims 1 to 3, characterized in that in the interpretation of the destination address, a command header, an offset value for fields of from the command header to the destination address, the number of fields in the destination address, and a setting method of the destination address are used as parameters.

5. The radio communication device as stated in one of claims 1 to 4, characterized in that the radio communication device is hardwired to a source DTE and is thereby used, and a radio packet including a destination address included in a packet transmitted from the source DTE as a destination radio-communication-device address can be transmitted in a radio coverage area between the radio communication device and a different radio communication device.

6. A communication system wherein wireless transmission of packets each including a destination address is performed between a plurality of DTEs by using a radio communication device, characterized in that the radio communication device is set to have the address identical to an address allocated to the DTE as an own address thereof in the communication system, performs interpretation of a destination address included in a packet received from a different radio communication device, and performs a transmission operation of the packet corresponding to the interpretation.

7. The communication system as stated in claim 6, characterized in that in the interpretation of the destination address, a command header, an offset value for fields of from the command header to the destination address, the number of fields in the destination address, and a setting method of the destination address are used as parameters.

8. A communication system wherein packets each including a destination address are transmitted from a source DTE to a plurality of destination DTEs by radio communication devices, characterized in that the radio communication devices are individually hardwired to the source DTE and the destination DTE, each of the radio communication devices is set to have an address identical to an address allocated to the hardwired DTE as an own address thereof in the communication system, performs interpretation of a destination address included in a packet received from a different radio communication device, and performs a transmission operation of the packet corresponding to the interpretation.

9. The communication system as stated in claim 8, characterized in that in the case of performing transmission of the packet between the radio communication device of the source DTE and the radio communication device of the destination DTE, when relaying is performed by using the radio communication devices hardwired to the DTEs, the addresses of the DTEs connected thereto are set as addresses of the relay radio devices in the communication system.

10. The communication system as stated in claim 8, characterized in that in the case of performing transmission of the packet between the radio communication device of the source DTE and the radio communication device of the destination DTE, when relaying is performed by using standalone radio communication devices, addresses of the relay radio devices in the communication system are allocated and set corresponding to the addresses of the DTEs.
